(19) United States
(12) Patent Application Publication
(10) Pub. No.: US 2026/0335934 A1
(43) Pub. Date: Oct. 29, 2026

(54) DISC SORTING MACHINE WITH PROTECTIVE SLEEVE

(71) Applicant: Lignum Technologies AG, Niederteufen (CH)

(72) Inventor: Romeo PALADIN, Oderzo (IT)

(21) Appl. No.: 19/106,268

(22) PCT Filed: Aug. 24, 2023
(86) PCT No.: PCT/EP2023/073205

§ 371 Date: Feb. 25, 2025

(30) Foreign Application Priority Data
Aug. 25, 2022 (IT) 102022000017610

(51) Int. Cl. B07B 13/14; B07B 1/15; B07B 13/04

(52) U.S. Cl. CPC B07B 13/14; B07B 1/15; B07B 13/04

(57) ABSTRACT

A separating sorting machine is described for treating heterogeneous products, coming from the most disparate sources, in order to obtain the desired fractional separation of the components present in the material to be treated. The separation is finalized for a specific use. The machine includes an organized plurality of selector units in reciprocal cooperation, each selector unit including a rotating shaft, a desired plurality of selector-drawing discs, and a plurality of tubular elements preventing the rolling of long elements on the rotating shaft.

### FIELD OF THE INVENTION

The present invention concerns a perfected machine for separating-sorting split material, for example deriving from solid waste, or even chips from untreated wood, advantageously, but not exclusively, for obtaining chips or like, similar or assimilable products in wood, plastic or other materials.

More precisely, the present invention concerns separating-sorting machines which must treat split material of heterogeneous products, coming from the most disparate sources, in order to obtain the desired separation of the components present in the material to be treated.

Said separation must occur in a manner finalized for the specific use.

The practical application of the invention, in particular but not exclusively in the case of obtaining chips, allows to obtain a specific and general yield, which is better with respect to the known art.

### BACKGROUND OF THE INVENTION

The separating-sorting machines to which the invention refers are disc screens which have a plurality of shafts, or axes, which are normally parallel to each other. Normally said shafts are coplanar, but they can also be positioned on two or more heights, i.e., or even on a non-horizontal plane.

Said shafts have, in a coordinated manner, a plurality of drawing discs placed at intervals from each other.

While helping the material to be screened to advance, the discs prepare it for selection and select it in the desired terms.

The separator-sorting screens according to the invention have the purpose of being able to treat a wide spectrum of waste, salvage or scraps, having an adequate consistency, such as: industrial technical waste, solid urban waste, waste from various industrial processes in the wood, plastic, textile sector and also waste from the agricultural sector such as compost, algae, herbs and loose and not-loose products in general.

Furthermore, the purpose is to solve the problem which is found in the known screens with selector discs, when urban or heterogeneous waste is to be treated; said problem is due to the fact that the light, long and more or less flexible bodies, such as threads, ropes, rags, plastics, paper, or similar or like products, etc., are twisted around the axes, which provide motion to the rollers, clogging them and reducing the sorting capacity until it is eliminated.

This entails, in the extreme, the obstruction of the spaces between the axes and between the axes and the discs, nullifying the screening action and reducing the yield.

It is known to make a screen with selector discs in which an attempt is made to prevent, with a fair degree of probability, the aforementioned long, flexible and light bodies from twisting around the axes of the rollers, clogging the screen itself, reducing the sorting capacity thereof and extending the time thereof in terms of less amount sorted, also for the necessary restoration interventions.

The known solution provides making a screen in which discs of polygonal shape are used, which peripherally have lateral, axial or inclined extensions, normally placed on both sides.

The known solutions have, around the selector shafts, cylindrical tubular elements or cylindrical sleeves, free to rotate independently with respect to the aforementioned shafts.

Said known solutions, with said cylindrical tubular elements or cylindrical sleeves, can cooperate with weights placed inside or outside said elements.

It should be noted that the axial, or inclined, extensions, placed on both sides of the drawing discs in the known solutions, impact the hourly production because the discharge opening is notably reduced and said extensions can also interact with the material, creating snags or other.

Furthermore, the fins placed on the sides of the discs are affected by the impacts, even violent, that the material to be treated generates so that they either flex or let the material to be treated slip between the discs, creating clogging, encumbrances, impediments to the free flow of the material to be sorted.

A disadvantage of the known solutions is given by the fact that the cylindrical sleeves, having a circular section, are also brought into rotation by the shaft on which they are installed due to the friction which is generated between the shaft and the cylindrical sleeves weighed down by the material to be treated acting thereon. When the cylindrical sleeves rotate together with the shaft, they carry with them any elongated flexible elements such as wires, rags, paper and plastic sheets, etc, which tend to twist, creating tangles which, in order to be removed, require stopping the machine and cutting with cutting devices such as grinders or similar.

In order to attempt to solve such a problem, solutions have been developed which involve weighing down the cylindrical sleeves to counteract the tendency thereof to rotate.

Document WO2011/0456565A1 describes a screen for separating solids, comprising a plurality of rotating shafts on which selector discs are positioned alternating with sleeves inside which a stabilizer body is peripherally arranged. The sleeves comprise an internal tubular body having dimensions corresponding to those of the rotating shaft and an external tubular body and the space between the two tubular bodies is filled with a filling material in which the stabilizer body is immersed. This solution has the drawback that the weight of the stabilizing body tends to wear out the sleeves prematurely.

Document IT2020000021796A describes a perfected screening system for glass recovery comprising a plurality of rotating shafts on which selector discs provided with protruding teeth are arranged, alternated with spacer elements which have a full elliptical shape and comprise an eccentrically arranged through hole having dimensions substantially equal to those of the rotating shaft. According to such a document, the spacer elements can rotate even if for a limited stroke with respect to the shaft, whereby do not solve the problems indicated above.

EP1358020B1, EP3771499A1, US8646615B2 and EP3922356A1 describe other known selector devices.

One purpose of the present invention is to make a separating sorting machine that is able to prevent the generation of lacings in the material to be treated that could obstruct the discharge gaps between the rollers and prevent the functioning thereof.

Another purpose is to prevent material from being twisted on the tubular elements.

One purpose of the present invention is to provide a separating sorting machine which tends to provide a greater guarantee regarding the quality of the sorting, at the same time it tends to obtain a better yield in terms of productivity for the improved drawing capacity of the material to be sorted by the discs themselves.

Furthermore, another purpose of the invention is to provide a separating sorting machine suitable for also treating pre-milled or chips of fresh or recycled wood, which must be sorted by thickness or, even, by reasonable length.

Yet another purpose of the invention is to eliminate the need to provide weights, tending to avoid the rotation of the tubular elements, placed covering the rotating shaft, that would prematurely wear out the tubular elements.

Therefore, the technical problem that the invention wants to solve consists in creating a simplified separating sorting machine with discs which is suitable for screening urban solid waste as well as other materials similar thereto, identified above by way of example.

At the same time, a purpose of the invention is to improve the drawing effect of the material to be treated, normally avoiding filiform or similar and/or long, flexible and light, or the like, products from being wound around the selector shafts.

Yet another purpose of the invention is that of strongly reducing, or rather eliminating, unwanted stops of the machine, for example those for twisting or clogging.

### SUMMARY OF THE INVENTION

The present invention concerns a perfected separating sorting machine, suitable for treating heterogeneous products, coming from the most disparate sources, in order to obtain the desired separation of the components present in the material to be treated, said separation operation being finalized for the specific use.

The invention provides that in the sorting machine, there is a plurality of selector units in reciprocal cooperation, each comprising a rotating shaft, a plurality of improved selector-drawing discs, in addition to a plurality of tubular elements preventing the rolling of light, long and/or flexible elements, or similar, on the rotating shaft, alternated with the selector-drawing discs.

The element preventing the rolling is preferably autonomous, i.e., it is not connected to the rotating shaft and/or to the selector discs.

According to the present invention, the lying plane of the axis of the rollers does not necessarily have to be horizontal, i.e., everything lying on the same plane. According to a variant, the sorting plane may also be inclined, or can have one or more steps; said steps may be horizontal, i.e., all or part may be inclined in the feed direction.

Still according to the invention, not necessarily all the discs must rotate at the same speed, as the distances between the shafts may also be different in one or more situations to be treated.

The present invention further provides that the tubular, anti-clogging elements, present idle on the disc-holder shafts, and between one selector disc and the other, have an oval shape, advantageously but not necessarily, coordinated with the section of the shaft. The tubular elements substantially enclose and protect the free part of the rotating shaft arranged between two successive selector-drawing discs.

According to the present invention, said tubular elements have a hollow oval section defining a housing compartment for said rotating shaft, in which said housing compartment is configured to allow a vertical oscillation movement of said tubular element with respect to said rotating shaft.

In other words, the oval section of the tubular element and of the housing compartment is configured so that when the rotating shaft is inserted in the tubular element, a free space remains between an internal wall of the tubular element and an external surface of the rotating shaft which allows an oscillation, i.e., a vertical movement of the tubular member.

By its nature, the oval shape prevents twisting, as it does not rotate while it lets the long, light, flexible and/or threadlike, or similar elements slip.

Furthermore, according to the present invention, on the basis of studies and extensive experiments, the selector discs have widths suitable for the purpose from time to time; they do not have the axial, or inclined, extensions placed on both sides of the drawing discs as in the known solutions which create problems in many operating situations.

According to the invention, the discs peripherally have from three to nine or more peripheral walls having flat or substantially flat surface as a whole, not necessarily uniform, which define a polygonal shape of the discs.

At least one of said surfaces, according to a first solution, may be not homogeneous with the others.

According to a variant, said surfaces are homogeneous.

Further, said surfaces are flat, but according to a variant they may have surface modifications which may involve planarity and/or surface shape.

According to a first formulation, at least one of said peripheral walls is substantially parallel to the rotation axis.

According to a first variant, at least one of the peripheral walls has an angle with respect to the rotation axis.

According to a further variant, the angle is not the same for all said flat peripheral walls of a disc and/or of the plurality of discs.

According to a further variant, the peripheral walls may have surfaces provided with undulations, i.e., a combination of the aforementioned modifications.

With these expedients, the extension of the materials which can be treated is significantly expanded and such as to modify the result in relation to the product to be treated, also in relation to the result sought.

The peripheral presence of flat surfaces, or substantially flat in the set of one or the other of the possible embodiments identified above, improves the drawing and sorting effect of the selector-drawing discs; this is because also said surfaces, with the wall function they perform, contribute to the drawing and to the interference action with the material and thus the sorting.

According to a variant, at least one of the lateral walls is orthogonal to the rotation axis.

According to another variant, at least one of the lateral walls advantageously has an angle with respect to the rotation axis, an angle which can be even a few degrees, possibly also placed in a negative direction, thus avoiding jamming and improving the sorting effect.

According to a further variant, at least one surface of a peripheral wall of at least one selector disc may have, according to the material to be treated, more or less rounded shapes in various ways, i.e., cusp-shaped, i.e., with more or less accentuated undulations.

According to the invention, the selector discs have the periphery shaped like a polygon, advantageously, but without limitation, the solution with seven sides is considered preferable, which is the one most used in relation to the average material to be treated and the average result required, on the filing date of the invention.

However, it is in the spirit of the invention to also provide a smaller or greater number of sides, such as six or eight or nine, up to ten, according to the material to be sorted and/or the type of product required, in any case without the peripheral lateral extensions present in the background art which create problems.

With the expedients according to the invention, a machine capable of treating heterogeneous waste is obtained, which from time to time can be equipped in relation to specific or particular waste, being adaptable to a wide range of specific needs, therefore being of a type which can be finalized, which instead does not occur in the background art. In fact, everything on the market is mainly finalized at pre-milled, or fresh or recycled wood chips.

Furthermore, with a machine made according to the invention, it is possible to predefine the length of the sorted product with good approximation.

Furthermore, the solution according to the invention allows obtaining a screening without slowing down or blockages due to jamming, for example but not exclusively, between the lateral extensions of the selector discs.

It is a characteristic of the invention to avoid what occurs in the background art, i.e., that the free tubular elements on the shaft tend to be brought into rotation, losing the capacity for which they are conceived.

Further, the absence of the extensions on the lateral walls, whether flat, cylindrical or V-shaped, typical of the background art, prevents the chips from being drawn, or jamming, between the lateral walls of the discs of two close shafts, slowing down the sorting speed, sometimes up to blocking.

According to the invention, different conditions are provided for obtaining the various components and their assembly, this in order to meet all the needs of a correct and desired sorting, according to the starting material and the desired result.

The specific setting of the invention also greatly reduces slowdowns and stops and expands the usability of the sorting machines.

In fact, the invention is aimed at coping with the considerable variables, including operating ones, which have, and will have, the desired achievement of the chips to be sorted.

In fact, with the present invention it is possible to configure, also from time to time, a separating sorting machine such that it satisfies most of the needs which arise, in order to obtain the desired chips, starting from the average of the material to be sorted present on the market.

This is because the separating sorting machine according to the invention allows to meet practically every need, allowing different combinations according to the desired result in terms of sorting and in terms of sorting continuity.

According to the material to be sorted, the selector-drawing discs have a width ranging from 20 to 100 mm, said discs being able to be full or empty also according to the rotation speed and/or the type of material to be treated.

According to a preferred embodiment, the selector-drawing discs have a width ranging from 20 to 80 mm.

Similarly, the selector discs have a polygonal figure that enters, substantially although not necessarily, in a circle whose diameter can vary from about 200 to about 400 mm, according to the material to be treated and the product sought. The peripheral speed of the selector discs can advantageously be comprised between 1.0 and 1.4 m/sec According to the invention, the distance of a selector disc placed on a shaft, with respect to the selector disc with which it cooperates, placed on the other previous or subsequent shaft, varies from 8 to 60 mm according to the material to be treated and the product sought.

According to the invention, the closest distance of the periphery of a selector disc with respect to the oval tubular anti-clogging element of the nearest shaft, varies from 10 to 25 mm, with the machine stationary, according to the material to be treated and the product sought.

The tubular elements, which remain floating on the shaft of a selector unit, substantially have an oval shape with the two smaller radii related to the diameter of the sorting shaft on which they lie.

Given the nominal diameter of the shaft equal to 100, the minimum internal width of the ring of the substantially oval tubular element will advantageously be comprised between 112 and 125, while the minimum internal length will be comprised between 119 and 144, the two dimensions being connected in relation to the diameter of the shaft; all being related to the material to be treated and the product sought, so that minimum variations to the indicated values are comprised in the invention.

According to the invention, it will be advantageous if the ring of the tubular element has a minimum thickness of 4-5 mm.

According to the invention, the lateral distance between two selector discs placed on respective nearby shafts is comprised from time to time between 8 and 60 mm, while the width of the selector discs, coordinated with the material to be treated, is comprised between 20 and 80 mm.

Said lateral distance I, in particular cases related to sorting problems, may vary at least between two sets of selector discs.

According to the invention, the minimum distance between a selector disc and the tubular element with which it directly cooperates is comprised between 10 and 25 mm according to the material to be treated.

### BRIEF DESCRIPTION OF THE DRAWINGS

Further characteristics and advantages of the present invention will become apparent from the detailed description of some preferred, but not exclusive, embodiments of selector units.

Said embodiments are illustrated merely by way of non-limiting example, in the attached drawing in which:

FIG. 1 shows a pair of selector units for a separating sorting machine according to the invention, with the selector discs exemplarily having six sides;

FIG. 2 shows a pair of selector units with the selector discs exemplarily having seven sides;

FIGS. 3 and 4 exemplarily illustrate two possible embodiments of setting.

### DETAILED DESCRIPTION OF THE DRAWINGS

In the drawings there are shown a pair of selector units 10 suitable to be used in a separating sorting machine 20.

A separating sorting machine 20 for treating heterogeneous products is generally described, but the functional equipment from time to time, which defines the factors to be used, is advantageously determined by the specific material to be treated while considering the product to be obtained. The material to be processed is of the split type, for example deriving from solid waste, or even wood chips.

Each selector unit 10 has a rotating shaft 12, which can be cylindrical or polygonal, torsionally integral with selector-drawing discs 11, 111 with keys, pins or by geometric ratio between the size of the shaft 12 and a hole present in the selector disc 11.

In the following, the “selector-drawing discs” will also be called “selector discs” or simply “discs”.

Said selector discs 11 may be empty or full according to factors of use and their positioning.

Exemplarily, the selector discs 11, 111 can be kept spaced by special spacer elements 19, having a tubukar shape, cooperating directly with the shaft 12, or by locking/positioning means, not illustrated herein.

In the illustrated case, said shaft 12, between one selector disc 11, 111 and the subsequent one, or the preceding one, advantageously cooperates with a tubular covering element 14 which is advantageously left free to possibly move with respect to the shaft 12.

Tubular elements 14 can be arranged at least partially above the spacer elements 19.

The tubular element 14 is oval, but could also be polygonal, substantially it can be inscribed in an oval or similar shape.

According to embodiments, the tubular element 14 has a hollow oval section and defines a housing compartment 15 for the shaft 12.

The housing compartment 15 is such that between the shaft 12 and the tubular element 14, i.e., the internal surface of the latter, there is a free space 16 configured to allow an oscillation movement of the tubular element 14 with respect to the shaft 12.

The oval conformation of tubular element 14 entails that during no-load operation, i.e., in the absence of material to be treated, they can spin dragged by friction against shaft 12. During normal operation, with the material to be treated, the tubular elements 14 would tend to turn due to increased friction, but when engaged by flexible and elongated elements that tend to lace up, the lower part of the oval tubular element which, as the tubular element 14 rotates, tends to move with respect to a vertical plane and to rise, comes into contact with the material to be treated that advances and presses it back down, preventing rotation and thus lacing.

Thanks to the combination between the oval shape of the section and the free space 16, when the material to be treated is deposited on the tubular element 14 and the tubular element 14 is pressed against the shaft 12, the tubular element 14 is in fact only allowed one small oscillation movement with respect to a vertical plane, before being bring back in the vertical direction, preventing the rotation thereof with respect to the shaft 12.

The weight of the material to be treated on the tubular element 14 causes it to creep over the shaft 12, but when it moves relative to the vertical plane, the weight of the material to be treated bearing down on it returns the tubular element 14 to its initial position.

According to embodiments, the oval section of the tubular elements 14 has a minimum internal length comprised between 1.05 and 1.2 times a minimum internal width.

According to embodiments, the minimum internal width is only slightly greater than the diameter, or equivalent diameter of the shaft 12, for example comprised between 1.1 and 1.25 times such a diameter, whereby the free space 16 is defined between the shaft 12 and the extension in length of the housing compartment 15. According to embodiments, the free space 16 has an extension in the direction in length which is comprised between 0.4 and 0.6 times the diameter of the shaft 12.

According to the invention, according to the product to be treated, taken as a base the diameter of the shaft 12, in the exemplary case equal to 100 mm, or the circle where the polygon of the shaft 12 is inscribed, the minimum internal width of the oval section of the tubular element 14 will be comprised between 112 and 125 mm, while the minimum internal length will be comprised between 119 and 144 mm, the two dimensions being correlated in relation to the diameter of the shaft 12 according to the material to be treated.

In other words, the internal distance between the two minimum correlations, i.e., between the opposite points in the direction of width, of the tubular element 14 is comprised between 119 mm and 144 mm, while that between the two maximum correlations, i.e., between the opposite points in the direction of length, is comprised between 112 mm and 125 mm, the sides being connected.

Advantageously but not necessarily, the thickness S of the tubular element 14 will be comprised between 4 and 6 mm, advantageously 5 mm.

Preferably, such a thickness is constant over the entire peripheral development.

The discs 11, 111 have a polygonal configuration defined by a plurality of peripheral walls 17 and lateral walls 18. The periphery of the discs 11, 111 can be hexagonal, heptagonal or octagonal, or with nine or more faces 13, or sides, according to the product to be treated and the effect sought from time to time on the material to be processed.

The discs 11,111, which according to the material to be treated have a width L placed between 20 and 100 mm, preferably between 20 and 80 mm, and advantageously do not have undercuts, may however have the lateral faces 13 more or less inclined.

Said lateral faces 13 with their orthogonal or inclined peripheral surfaces, may be flat or have uniform, non-uniform imperfections, i.e., degrading in the required direction.

Rotating, the discs 11, 111 perform the function of bouncing the material which then falls thereon, according to the type of material to be treated and the rotation speed.

According to the invention, the discs 11, 111 are rotated at a peripheral speed placed around 1.0 m/sec up to around 1.4 m/sec, advantageously in inverse ratio to the density/composition of the material to be treated.

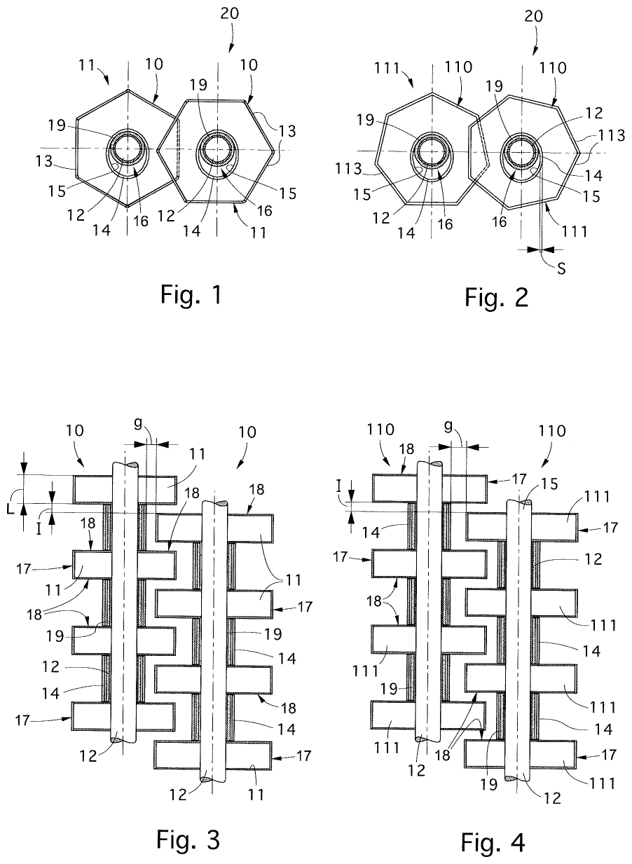

In the example of FIG. 1, two discs 11 are illustrated which have six faces 13, i.e., six sides, useful in the event that light materials are treated, such as recycled dry wood, which vigorously bounce on the faces 13 of said discs 11, 111, receiving energetic distancing actions before falling back.

These actions break up the mass to be screened and improve the separation thereof thanks to the multiple and repeated actions.

The presence of the greater length of the faces or sides 13, in relation to the inscription diameter, increases the projection upwards and also improves the effect of the disintegration of the mass generated by falling back.

The surface shape of the faces 13 and the lateral walls 18 determines a

different action on the mass to be treated and on the individual components of said mass.

The example of the selector units 110 with discs 111 having seven faces or sides 113 (FIG. 2) is also illustrated but, according to the material to be treated, discs with a greater number of sides, at least up to nine, may be provided.

The discs 111 having seven faces or sides 113, thus shorter sides with the same inscription diameter with respect to those of FIG. 1—are more suitable for treating heavy materials, or heavier than those treated with the discs 11 with six sides 13, for example wet chips of fresh wood, which are advantageously used because said chips disintegrate with fewer bounces.

Advantageously, the discs 11, 111 can also have eight or nine sides-thus shorter sides with the same inscription diameter—when materials must be treated which are more demanding, or heavier than those previously indicated, such as compost or the like, which are brittle and contain aggregates or heavy bodies which can damage the selector discs.

According to the invention with these characteristics, the various categories of known products can be managed virtuously in order to reduce them into chips, at the same time obtaining an excellent balance between productivity, management costs and maintenance costs.

In the exemplary embodiment illustrated in FIG. 1, the discs 11 are empty and have a polygonal shape with six sides 13, while in the exemplary embodiment of FIG. 2 the discs 111 are empty and have a polygonal shape with seven sides 113. As indicated, according to the type of material to be treated, there may also be discs with eight, or nine sides, furthermore said discs may also be full both for reasons of durability and for reasons of wear according to the material to be treated.

In a screen, i.e., in a machine 20, according to the material to be treated, the discs 11, 111 can be all or partly empty or all or partly full, i.e., partly full and partly empty, for example in the first rows concerned the discs 11, 111 can be full and then in the last rows they can also be empty.

The sides, or faces 13, 113 of the discs 11, 111 can be flat or provided with surface modifications, i.e., curved, or have transverse or variously positioned reliefs or recesses, this due to the average constitution of the product to be treated and therefore the needs which materialize from time to time.

The invention, also as indicated below, makes it possible to adapt the discs 11, 111, also according to particular materials to be broken down, having the reasonable certainty of the result sought.

Tubular elements 14, having an oval shape, are arranged between the discs 11, 111 and cooperate with the free parts of the shaft 12.

The width “L” of the discs 11, 111 is a function of the average characteristics of the material to be treated and varies from about 20 mm to 100 mm, advantageously from about 20 to 80 mm.

There is the possibility, in the spirit of the invention, that if the material to be treated requires it, that shafts 12 carrying discs in sequence are equipped with discs 11, 111 having different widths.

The lateral walls 18 of the discs 11, 111 can have characteristic shapes according to the material to be treated; thus, for example, they can be parallel, or one, or both, inclined towards the shaft 12 to widen the interspace with respect thereto in order to avoid jamming; such expedients depending on different factors, in particular the average type of material to be treated and the drawing effect sought on the material to be treated.

Therefore, the lateral walls 18 of the discs 11, 111 may be substantially orthogonal to the axis 12, or have a slight inclination, both positive and negative; said walls may be smooth or have uniform deformations, or of various types, in order to possibly contribute to the breaking down.

The distance “g”, between the external periphery of a disc 11 of a selector unit 10 and the periphery of the tubular element 14 placed on the shaft 12 of an adjacent selector unit 10, according to the invention can be provided according to the product to be processed; normally a distance of around 10-25 mm is provided.

According to the invention, the separating sorting machine 20 can have the distance between the drawing shafts 12 fixed, in which case the material to be treated must fall within a defined range.

It is, however, in the spirit of the invention to envisage the possibility of positioning the shafts 12 within a desired range of distances.

According to embodiments it may be provided that at least two different distances are present between respective pairs of adjacent shafts 12 of the machine 20.

According to a possible geometric formulation of the invention, according to the final product sought, starting from recycled wood to respectively obtain micro-chips and macro-chips finalized at obtaining chipboard, there could be two exemplary cases:

### EXAMPLES

### A—Wood Micro-Chip Separation

11, 111-selector discs: 250 mm external diameter;
I—opening/lateral distance: from 10 mm;
L—width/thickness.: from 30 mm;
g—gap/distance: from 12.5 mm;
N—peripheral speed: from 95 rpm/ 1.24 m/sec;
Screen width: 1.6 m→Yield: 12/17 m3/h chips/roller;
Screen width: 2.2 m→Yield: 18/25 m3/h chips/roller.

### B—Wood Macro-Chip Separation

11, 111-selector discs: 250 mm external diameter;
I—opening/lateral distance: from 30 mm;
g—gap/distance: from 12.5 mm;
N—rotation speed: from 95 rpm;
Screen width 1.6 m→Yield 22/27 m3/h chips/roller;
Screen width 2.2 m→Yield 32/37 m3/h chips/roller.

According to the invention, in general:
the width L of the discs 11, 111 is comprised between 20 and 80 mm;
the lateral distance I between two cooperating discs 11, 111 placed on two consequent shafts 12, is comprised between 8 and 60 mm;
a tubular element 14 in the rest position leaves free, with respect to the previous or subsequent disc 11, 111 with which it works, from 10 to 25 mm.

It is indifferent here how the micro and macro chip fractions can be separated. The idea of a solution was presented with the related practical results obtained in relation to two different needs.

According to a variant, the distance between the rotating shafts 12 can be adjustable in order to be able to vary the range of products to be treated.

A practical embodiment of the invention has been illustrated, but variants using the solution idea are possible.

1. A separating sorting machine for treating heterogeneous split material and products to obtain fractional separation of components present in the material, the said machine comprising:
a plurality of selector units in reciprocal cooperation, each selector unit comprising a rotating shaft on which are arranged a plurality of selector-drawing discs and a plurality of tubular elements preventing rolling of long flexible elements on the rotating shaft alternated with the discs,
wherein the tubular elements have a hollow oval section defining a housing compartment for the rotating shaft such that, between the rotating shaft and the tubular element, there is a free space configured to allow an oscillation movement of the tubular element with respect to the rotating shaft,
wherein the plurality of selector-drawing discs are distanced at a pitch functional for the product, and have a polygonal shape, defined by lateral walls bordering peripheral walls,
wherein the discs have a width of between 20 and 100 mm while the polygonal shape provides between six and nine faces substantially inscribed in a circle with a diameter of between 200 and 400 mm, and
wherein the width of the discs and the diameter inscribing the circle are functionally related to the type of the product and/or of chips to be separated.

2. The machine of claim 1, wherein the oval section of the tubular elements has a minimum internal length of between 1.05 and 1.2 times a minimum internal width.

3. The machine of claim 1, wherein the free space has an extension in a direction in length of between 0.4 and 0.6 times the diameter of the shaft.

4. The machine of claim 1, wherein the oval section of the tubular elements with respect to the diameter of the rotating shaft, given a nominal diameter of the shaft equal to 100, has a minimum internal width of between 112 and 125, and a minimum internal length of between 119 and 144, the minimum internal width and the minimum internal length being correlated in relation to the diameter of the rotating shaft.

5. The machine of claim 1, wherein the selector-drawing discs, keyed on the respective shaft, have a width, according to the material, of between 20 and 80 mm.

6. The machine of claim 1, wherein the selector-drawing discs have the faces of the peripheral polygon; orthogonal to the lateral walls, and the faces have a width of between 20 and 80 mm, according to the type of the material.

7. The machine of claim 1, wherein opposite selector-drawing discs have a reciprocal lateral distance of between 8 and 60 mm according to the material.

8. The machine of claim 1, wherein the distance between the peripheral part of the disc furthest from its axis and the periphery of the contiguous rotating shaft it faces, comprising the stationary tubular element, is between 10 and 25 mm according to the material.

9. The machine of claim 1, wherein the rotation speed of at least the plurality of discs is between 1.0 and 1.4 m/sec according to the material.

10. The machine of claim 1, wherein each tubular element has a minimum thickness of between 4-6 mm.

11. The machine of claim 1, wherein at least one of the peripheral walls of at least one disc has surface modifications.

12. The machine of claim 1, wherein at least one of the lateral walls of at least one disc has surface modifications.

13. The machine of claim 1, wherein at least one of the peripheral walls of at least one disc has a development which tapers toward the center.

14. The machine of claim 1, wherein the widths of the discs are different in at least one shaft.

15. The machine of claim 1, wherein the machine has at least two different distances between successive shafts.

16. The machine of claim 5, wherein the polygonal shape has six, seven, eight, or nine faces according to the material.
